(19) United States
(12) Patent Application Publication
(10) Pub. No.: US 2023/0371485 A1
(43) Pub. Date: Nov. 23, 2023

(54) FISHING ROD

(71) Applicant: Shenzhen Bosaidong Technology Co., Ltd., Shenzhen (CN)

(72) Inventor: Tianshi Cui, Shenzhen (CN)

(21) Appl. No.: 17/884,585

(22) Filed: Aug. 10, 2022

(30) Foreign Application Priority Data
May 20, 2022 (CN) 202221237006.7

(51) Int. Cl. A01K 87/00

(52) U.S. Cl. CPC A01K 87/009

(57) ABSTRACT

Provided is a fishing rod which includes a rod body, a hooking member, and a reel base. A fishing line with a fish hook connected to an end thereof is wound around the rod body, the reel base is connected to a rear end of the rod body, and the hooking member is sleeved on the rod body and is located at a front end of the reel base. The hooking member is provided with a hooking hole in which the fish hook is hooked. Compared with the prior art, in the present disclosure, a hooking hole is provided on hooking member, so that the fish hook can be hooked in the hooking hole after the fishing, in order to avoid the fish hook from scratching the rod body which affects the aesthetics of the fishing rod and causes wear to the fish hook, thereby improving user experience.

### CROSS REFERENCE TO RELATED APPLICATION

The present application claims priority from Chinese patent application No. 202221237006.7 filed on May 20, 2022, the entire content of which is incorporated herein by reference.

### TECHNICAL FIELD

The present disclosure relates to the field of fishing tackle, and in particularly to a fishing rod.

### BACKGROUND TECHNOLOGY

Fishing has recently become a popular leisure activity. Current fishing rods on the market are formed with a metal hook extending outward from the rod body to catch the fish hook after fishing. Since the rod body may easily be scratched by the fish hook attached, which affects the appearance of the rod body, and the fish hook is prone to wearing, resulting in a short durability and affecting user experience.

### SUMMARY

An objective of the present disclosure is to provide a fishing rod which may improve user experience.

In order to solve the above-mentioned technical problem, the present disclosure provides a fishing rod which includes a rod body, a hooking member, and a reel base. A fishing line with a fish hook connected to an end thereof is wound around the rod body, the reel base is connected to a rear end of the rod body, and the hooking member is sleeved on the rod body and is located at a front end of the reel base. The hooking member is provided with a hooking hole in which the fish hook is hooked.

Further, the hooking member includes a base body and a reversed hook bending outward from one side of the base body. The hooking hole is formed between the reversed hook and the base body.

Further, the hooking member includes a base body and an arc-shaped plate extending outward from the base body, and the hooking hole is provided on the arc-shaped plate.

Further, a recess that fits the shape of a finger is provided on the base body.

Further, the hooking member is connected with the reel base through a threaded connecting member.

Further, the hooking member is made of plastic.

Further, a guiding ring is fixed on the rod body.

The advantageous effects of the present disclosure are that a hooking member is sleeved on the rod body of the fishing rod provided by the present disclosure, and a hooking hole is provided on hooking member, so that the fish hook can be hooked in the hooking hole after the fishing, in order to avoid the fish hook from scratching the rod body which affects the aesthetics of the fishing rod and causes wear to the fish hook, thereby improving user experience.

### BRIEF DESCRIPTION OF THE DRAWINGS

FIG. 1 is a structural view of a first embodiment of a fishing rod of the present disclosure;

FIG. 2 is an enlarged view of part A of the fishing rod shown in FIG. 1;

FIG. 3 is a structural view of a second embodiment of the fishing rod of the present disclosure; and

FIG. 4 is an enlarged view of part B of the fishing rod shown in FIG. 3.

### DESCRIPTION OF THE EMBODIMENTS

The present disclosure will be further described below in conjunction with the accompanying drawings and embodiments in order to enable those of ordinary skill in the art to more clearly understand the objectives, technical proposals, and advantages of the present disclosure.

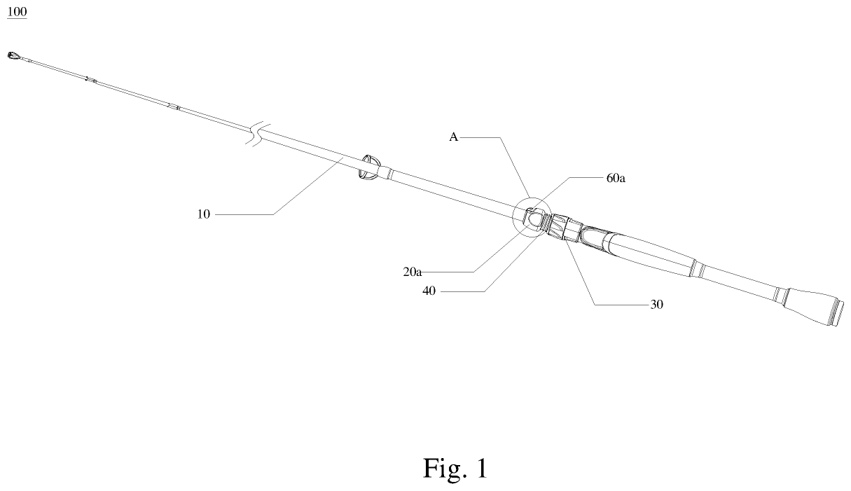

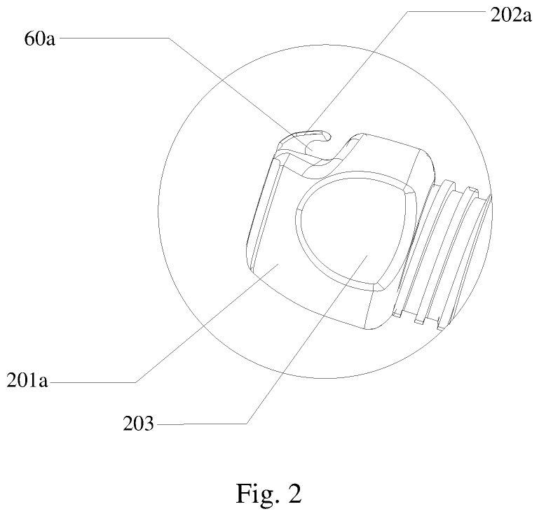

Referring to FIGS. 1 and 2, a first embodiment of a fishing rod 100 provided by the present disclosure is shown in FIGS. 1 and 2. In this embodiment, the fishing rod 100 includes a rod body 10, a hooking member 20a, and a reel base 30. A fishing line with a fish hook connected to an end thereof is wound around the rod body 10, the reel base 30 is connected to a rear end of the rod body 10, and the hooking member 20a is sleeved on the rod body 10 and is located at a front end of the reel base 30. The hooking member 20a is provided with a hooking hole 60a in which the fish hook is hooked. Preferably, in other embodiments, a guiding ring for guiding the fishing line may be provided on the rod body 10. Based on the above-mentioned design, the fish hook can be hooked in the hooking hole 60a of the hooking member 20a on the fishing rod 100 after the fishing is completed to avoid the fish hook from scratching the rod body 10 and affecting the aesthetics of the fishing rod 100. This may also reduce the possibility of fish escaping due to the wear of the fish hook resulted from scraping the rod body 10, thereby improving user experience.

Preferably, in this embodiment, the hooking member 20a is made of plastic, so as to protect the fish hook from wearing by attaching the fish hook to the hooking hole 60a. The hooking member 20a includes a base body 201a and a reversed hook 201b bending outward from one side of the base body 201a, and the hooking hole 60a is formed between the reversed hook 201b and the base body 201a. The hooking member 20a is connected to the reel base 30 through a threaded connecting member 40. Based on the above design, the fish hook is hooked in the hooking hole 60a formed between the reversed hook 201b and the base body 201a that are made of plastic, which may reduce the damage to the fish hook. The hooking member 20a is connected with the reel base 30 through the threaded connecting member 40, which increases the space for holding the fishing rod 100, and also increases the force of dragging the fish.

Referring to FIG. 2, furthermore, in this embodiment, the base body 201a is provided with a recess 203 that fits the shape of a finger, so as to facilitate grasping the fishing rod when fishing.

In summary, the present disclosure provides a separate hooking member 20a on the rod body 10, which prevents the rod body 10 from being scratched by the fish hook, and protects the fish hook through the plastic hooking member 20a in order to reduce the possibility that the fish may escape. Moreover, the hooking member 20a is connected to the reel base 30 through the threaded connecting member 40, which may provide a larger space for the user to grasp the fishing rod during fishing, and greatly increase the force of dragging a fish.

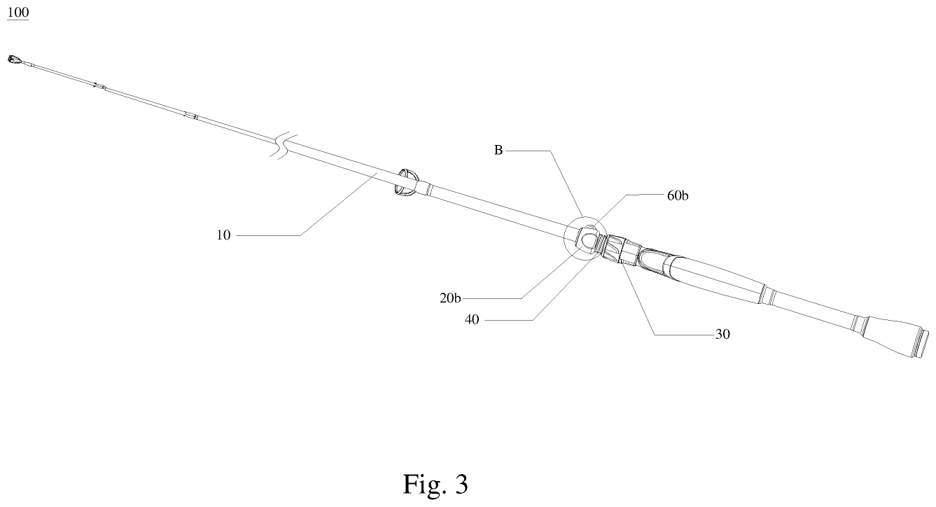

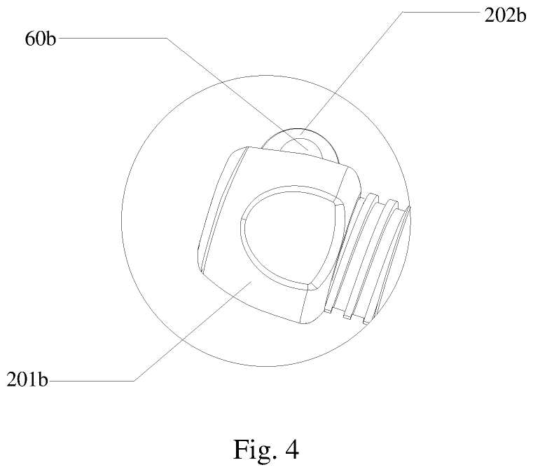

Referring to FIGS. 3 and 4, a second embodiment of the fishing rod 100 provided by the present disclosure is shown in FIGS. 3 and 4. The present embodiment is different from the first embodiment in the specific structure of the hooking member, and other structures are the same or similar. In this embodiment, the hooking member 20b includes a base body 201b and an arc-shaped plate 202b extending outward from the base body 201b, and the hooking hole 60b is provided on the arc-shaped plate 202b. It is understandable that the hooking member 20b in this embodiment is sleeved on the rod body 10, and is connected to the reel base 30 through the threaded connecting member 40. This increases the aesthetics of the fishing rod 100 and improves the user's experience.

The above descriptions are merely preferred embodiments of the present disclosure, and are not intended to limit the present disclosure. Various equivalent changes and modifications may be made by those skilled in the art on the basis of the above-mentioned embodiments, and all equivalent changes or modifications made within the scope of the claims shall fall within the scope of protection of the present disclosure.

What is claimed is:

1. A fishing rod, comprising:
a rod body;
a hooking member; and
a reel base,
wherein a fishing line with a fish hook connected to an end thereof is wound around the rod body, the reel base is connected to a rear end of the rod body, and the hooking member is sleeved on the rod body and is located at a front end of the reel base, the hooking member is provided with a hooking hole in which the fish hook is hooked.

2. The fishing rod of claim 1, wherein the hooking member includes a base body and a reversed hook bending outward from one side of the base body, and the hooking hole is formed between the reversed hook and the base body.

3. The fishing rod of claim 1, wherein the hooking member includes a base body and an arc-shaped plate extending outward from the base body, and the hooking hole is provided on the arc-shaped plate.

4. The fishing rod of claim 2, wherein a recess that fits shape of a finger is provided on the base body.

5. The fishing rod of claim 3, wherein a recess that fits shape of a finger is provided on the base body.

6. The fishing rod of claim 1, wherein the hooking member is connected with the reel base through a threaded connecting member.

7. The fishing rod of claim 1, wherein the hooking member is made of plastic.

8. The fishing rod of claim 1, wherein a guiding ring is fixed on the rod body.
